(19) United States
(12) Patent Application Publication
(10) Pub. No.: US 2007/0182110 A1
(43) Pub. Date: Aug. 9, 2007

(54) VEHICLE STABILIZER SYSTEM

(75) Inventor: Shingo URABABA, Toyota-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/668,273

(22) Filed: Jan. 29, 2007

(30) Foreign Application Priority Data
Feb. 9, 2006 (JP) 2006-032590

(51) Int. Cl. B60G 21/067; B60G 17/016; B60G 21/055

(52) U.S. Cl. 280/5.508; 280/5.511; 280/5.506

(57) ABSTRACT

A stabilizer system for a vehicle including: a pair of stabilizer apparatus provided for a front-wheel side and a rear-wheel side of the vehicle, each including a stabilizer bar connected at its opposite ends to respective wheel holding members for supporting left and right wheels, an actuator which includes an electric motor and which changes, by an operation of the motor, roll-restraining force exerted by the stabilizer bar, and a driver disposed between the motor and an electric power source for driving the motor; and a control device which controls the motor of each stabilizer apparatus via the driver and thereby controls an operation of the actuator, wherein the control device includes an under-both-driver-no-power-supply-state control portion which controls at least one of the drivers of the two stabilizer apparatus to be placed into a phase-interconnection operation state in which terminals of respective phases of the motor are electrically connected to each other, when both of the drivers of the two stabilizer apparatus are in a no-power-supply operation state in which no power is supplied from the power source to the motor.

This application is based on Japanese Patent Application No. 2006-032590 filed on Feb. 9, 2006, the contents of which are incorporated herein by reference.

### BACKGROUND OF THE INVENTION

1. Field of the Invention

The present invention relates in general to a stabilizer system installed on a vehicle, and more particularly to such a stabilizer system in which roll restraining force exerted by a stabilizer bar is changeable by an operation of an actuator.

2. Discussion of Related Art

In recent years, a stabilizer system as described in JP-A-2002-518245, that is, a so-called “active stabilizer system” is proposed and installed actually on some vehicles. The system includes an actuator having an electric motor as a drive source and is arranged such that roll restraining force to be exerted by a stabilizer bar is changeable by controlling an operation of the actuator.

### SUMMARY OF THE INVENTION

The actuator in the above-indicated active stabilizer system, in particular, the electric motor as the drive source for the actuator, is controlled via a driver such as an inverter. More specifically explained, the driver is disposed between the electric motor and an electric power source and arranged to control an electric power to be supplied from the power source to the electric motor. The operation of the actuator is controlled by transmitting control signals to the driver. In the meantime, a twisting amount of the stabilizer bar changes due to external input force arising from disturbance of a road surface, a variation in roll moment that acts on the vehicle body, and the like. Further, in the above-indicated stabilizer system, the actuator is operated also by such external input force. Namely, the electric motor is operated even by the external input force. Accordingly, even where no electric power is supplied from the power source to the electric motor, the electric motor functions as a generator and generates electric power when the electric motor is operated by the external input force. The thus generated electric power is inputted to the driver and supplied to the power source side depending upon the structure of the power source. Because this reverse power may impose a load on the driver or the power source, it is desirable to take such a reverse power into account in the active stabilizer system. By taking the reverse power into account, the utility of the system can be improved. The present invention was developed in the light of the situations described above. It is therefore an object of the invention to provide an active stabilizer system with high utility.

To achieve the object indicated above, a stabilizer system for a vehicle according to the present invention is arranged such that the roll restraining force to be exerted by the stabilizer bar is changeable by the operation of the actuator having the electric motor as a drive source and such that an operation state of at least one of a driver for the electric motor on the front-wheel side of the vehicle and a driver for the electric motor on the rear-wheel side of the vehicle is placed in a phase-interconnection operation state in which terminals of each phase of the electric motor are electrically connected to each other, when the operation state of both of the driver on the front-wheel side and the driver on the rear-wheel side is in a no-power-supply operation state in which no electric power is supplied from the power source to the electric motor.

Where the operation state of the driver is placed in the above-indicated phase-interconnection operation state, the electric power generated in the electric motor due to the external input force is consumed within that electric motor. Therefore, the electric power does not impose a load on the driver and a load on the power source. In the present stabilizer system, even when both of the drivers are in the above-indicated no-power-supply operation state, at least one of the two drivers is placed into the above-indicated phase-interconnection operation state, resulting in a load reduction for the driver or a load reduction for the power source. Thus, the stabilizer system according to the present invention assures high utility.

### Forms of Invention

There will be described in detail various forms of an invention which is considered claimable (hereinafter may be referred to as “claimable invention”). Each of the forms of the invention is numbered like the appended claims and depends from the other form or forms, where appropriate, for easier understanding of the invention. It is to be understood that the invention is not limited to the technical features or any combinations thereof which will be described, and shall be construed in the light of the following descriptions of the various forms and preferred embodiments of the invention. It is to be further understood that a plurality of elements or features included in any one of the following forms of the invention are not necessarily provided all together, and that any form in which one or more elements or one or more features is/are added to any one of the following forms and any form in which one or more elements or one or more features is/are deleted from any one of the following forms may be considered one form of the claimable invention.

(1) A stabilizer system for a vehicle comprising:

a pair of stabilizer apparatus one of which is provided for a front-wheel side of the vehicle while the other of which is provided for a rear-wheel side of the vehicle and each of which includes: a stabilizer bar connected at opposite ends thereof to respective wheel holding members which respectively support left and right wheels of the vehicle; an actuator which includes an electric motor and which changes, by an operation of the electric motor, roll-restraining force to be exerted by the stabilizer bar; and a driver which is disposed between the electric motor and an electric power source for driving the electric motor; and

a control device which controls the electric motor of each of the pair of stabilizer apparatus via the corresponding driver and thereby controls an operation of the corresponding actuator,

wherein the control device includes an under-both-driver-no-power-supply-state control portion which controls at least one of the drivers of the pair of stabilizer apparatus to be placed into a phase-interconnection operation state in which terminals of respective phases of the corresponding electric motor are electrically connected to each other, when both of the drivers of the pair of stabilizer apparatus are in a no-power-supply operation state in which no power is supplied from the power source to the electric motor.

The stabilizer system constructed according to the above-indicated form (1) is based on a so-called “active stabilizer system”. In detail, the present form is characterized in that the operation state of the driver for the electric motor of each actuator is changed as needed. The “driver” recited in the form includes inverters, for instance. The driver is disposed between the electric power source and the electric motor and has a function of controlling electric power to be supplied from the electric power source to the electric motor.

As explained above, the actuator is operated even by the external input force such as the disturbance of the road surface and the roll moment that acts on the vehicle body, and the electric motor of the actuator is also operated in accordance with the operation of the actuator. The electric motor functions as an electric generator when no power is supplied thereto from the electric power source. Accordingly, when the electric motor is operated by the external input force, the electric motor generates electric power based on electromotive force. The generated power is inputted to the driver and also to the power source depending upon the structure of the driver. This reverse acting of the electric power imposes a load on the driver. In some cases, such reverse acting of the electric power imposes a load on the power source. In the meantime, when the terminals of the respective phases of the electric motor are connected to each other, electric current based on the electric power generated by the electric motor circulates or flows in a closed path that includes coils of the electric motor. Accordingly, the load that acts on the driver and the power source due to the electric power generated by the electric motor is small, or no load is imposed on the driver and the power source.

According to the above form, under a situation in which there is a possibility of generation of electric power by both of the electric motor on the front-wheel side and the electric motor on the rear-wheel side, the above-mentioned reverse acting of the electric power generated by at least one of the two electric motors is obviated. Therefore, it is possible to reduce, in the stabilizer system as a whole, the load to be applied to the driver and the load to be applied to the power source.

The above-indicated “no-power-supply operation state” as one form of the operation state of the driver includes an operation state that corresponds to a free mode when the operation mode of the electric motor is placed in the free mode, for instance. More specifically explained, the no-power-supply operation state is an operation state that corresponds to an operation mode of the electric motor in which the actuator is allowed to be relatively freely operated by the external input force. Further, the above-indicated “phase-interconnection operation state” is one form of the no-power-supply operation state. In the phase-interconnection operation state, input terminals that correspond to the respective phases of the electric motor are connected to each other. The phase-interconnection operation state includes an operation state in which the terminals are short-circuited and an operation state in which the terminals are connected via resisters. In this respect, it is possible to regard, as the no-power-supply operation state, an operation state of the driver at the time when no power is actually supplied from the power source to the electric motor even when the operation mode of the electric motor is a control mode (in which the operation of the electric motor is controllable by the electric power supplied from the power source). More specifically, it is possible to regard, as the no-power-supply operation state, an operation state in which a duty ratio is made zero as explained below.

While the above-indicated “electric power source” does not exclude a plurality of electric power sources provided for supplying individually the electric power to the respective electric motors of the pair of stabilizer apparatus, the electric power source in this form is directed mainly to an electric power source capable of supplying the electric power to both of the electric power of the pair of stabilizer apparatus in common. The electric power source is constituted principally by a so-called battery. The electric power source may be constituted solely by the battery or may be constituted by including the battery and a converter for raising or lowering the voltage of the battery. Further, the electric power source may be capable of regenerating the electric power generated by the electric motor or may be incapable of regenerating the generated electric power. Where the regenerative power source is employed, it is possible to reduce a possibility of overcharge of the battery. Where the unregenerative battery is employed, it is possible to avoid an increase in the voltage of an output portion of the power source which arises from the electric power generated by the electric motor. Moreover, where the driver includes switching elements which will be described, it is possible to prevent or avoid damaging of the switching elements which arises from the voltage increase.

In the form indicated above, the structures of the stabilizer apparatus, the drivers, etc., are not particularly limited. Specific structures of the stabilizer apparatus, the driver, etc., suitably employed in this form will be explained in detail in the following forms.

(2) The stabilizer system according to the above form (1), wherein the driver of each of the pair of stabilizer apparatus includes: (A) a plurality of pairs of switching elements, each pair being provided for the terminal of each phase of the corresponding electric motor and including (a-1) a positive-side switching element which is operable to electrically connect the corresponding terminal and a positive-side terminal (128) of the electric power source to each other when the positive-side switching element is placed in an ON state and to disconnect the corresponding terminal and the positive-side terminal of the electric power source from each other when the positive-side switching element is placed in an OFF state and (a-2) a negative-side switching element which is operable to connect the corresponding terminal and a negative-side terminal (128) of the electric power source to each other when the negative-side switching element is placed in an ON state and to disconnect the corresponding terminal and the negative-side terminal of the electric power source from each other when the negative-side switching element is placed in an OFF state; and (B) a switching-element controller which selectively places each of the switching elements between the ON state and the OFF state.

The above-indicated form (2) employs, as the driver, an inverter with an ordinary structure. “Switching elements” of the driver in this form are not particularly limited. As the switching elements, there may be employed various elements such as those principally constituted by MOS-type FET and those principally constituted by bipolar-type transistors. As for the driver employing the MOS-type FET as the switching elements, the MOS-type FET per se is constructed as if it includes reflux diodes. Accordingly, the electric current based on the power generated by the electric motor can flow back toward the power source through the MOS-type FET per se. As for the driver employing the bipolar-type transistors as the switching elements, the reflux diodes are generally provided in the driver in parallel with the switching elements, and the electric current flows back toward the power source through the reflux diodes. Namely, according to this form, irrespective of the type of the switching elements, the backflow of the electric current toward the power source can be suppressed or prevented, whereby the load to be imposed on the power source can be reduced. In addition, where the voltage of the output portion of the power source is increased as a result of supplying, to the power source, the power that is generated by the electric motor, the switching elements may suffer from a load. In this instance, therefore, it is expected that the load to be imposed on the elements can be reduced.

The above-indicated “switching-element controller” broadly means a circuit for changing switching elements to adjust the electric power to be supplied, on the basis of commands issued from the control device indicated above. Where the electric motor is a brushless DC motor, the switching-element controller may have a function of executing changing of the switching elements in accordance with the electric angle of the electric motor. The switching-element controller may further have a function of changing a ratio (a duty ratio) of a pulse-on time to a pulse-off time by PMW (Pulse Width Modulation) to adjust the electric power to be supplied.

In the driver employed in the above form, the above-indicated no-power-supply operation state includes an operation state in which all of the positive-side switching elements or all of the negative-side switching elements are placed in the OFF state, so as to correspond to the free mode indicated above. As explained later, an operation state in which only the positive-side switching elements or only the negative-side switching elements are all placed in the ON state is also included in the no-power-supply operation state. In the operation state in which are executed the changing of the switching elements in accordance with the electric angle of the electric motor and the adjustment of the power to be supplied by changing of the duty ratio, so as to correspond to the control mode, it is possible to regard, as the no-power-supply operation state, an operation state in which the duty ratio is made zero and no power is substantially supplied from the power source to the electric motor.

(3) The stabilizer system according to the above form (2), wherein the under-both-driver-no-power-supply-state control portion controls at least one of the drivers of the pair of stabilizer apparatus to be placed in an operation state in which only the positive-side switching elements or only the negative-side switching elements are all placed in the ON state, when both of the drivers of the pair of stabilizer apparatus are in the no-power-supply operation state.

In the above-indicated form (3), where the driver having the switching elements is employed, the pattern of changing the elements when the driver is in the phase-interconnection operation state is specifically limited. According to this form, there is formed a closed electric current path that includes the electric motor via the switching elements or via the switching elements and the reflux diodes depending upon the structure of the driver, so that the electric current based on the generated power by the electric motor circulates in the path.

(4) The stabilizer system according to any one of the above forms (1)-(3), wherein the control device controls the operation of the actuator of each of the pair of stabilizer apparatus based on a turning condition of the vehicle and thereby executes a control which permits the corresponding stabilizer bar to exert the roll-restraining force in accordance with the turning condition of the vehicle.

The above-indicated form (4) specifically limits a control technique of the so-called active stabilizer. According to this form, since the roll restraining force exerted by the stabilizer bar is changed based on the turning condition of the vehicle, the rolling of the vehicle body during turning of the vehicle can be made appropriate. The above-indicated “turning condition of the vehicle” means a degree of severity of turning of the vehicle. In the actual control, the operation of the actuator may be controlled based on the roll moment that acts on the vehicle, more specifically, suitable parameters indicative of the degree of severity of turning of the vehicle such as the lateral acceleration occurring in the vehicle body, the yaw rate occurring in the vehicle, the vehicle speed, and the steering amount. In the control of the operation of the actuator, the force to be exerted by the actuator, i.e., the actuator force that is in correlation with the force to be exerted by the electric motor may be controlled or the operational amount of the actuator that is in correlation with the operational amount of the electric motor may be controlled. Where each of the actuator and the electric motor is of a rotary type, the operational amount of each of the actuator and the electric motor means a rotary amount of each of the actuator and the electric motor. More specifically explained, in a stabilizer apparatus in which the roll restraining force in accordance with the actuator force is exerted, the target roll restraining force which the stabilizer apparatus should bear may be determined on the basis of the turning condition of the vehicle and the actuator force may be controlled such that the stabilizer bar exerts the target roll restraining force. In a stabilizer apparatus in which the stiffness (the apparent stiffness) of the stabilizer bar depends on the operational amount of the actuator, the target actuator operational amount of the actuator may be determined on the basis of the turning condition of the vehicle to obtain the stiffness in accordance with the turning condition, and a control may be executed such that the operational amount of the actuator coincides with the determined target operational amount.

(5) The stabilizer system according to any one of the above forms (1)-(4), wherein the control device executes a control which permits the driver of each of the pair of stabilizer apparatus to be placed in the no-power-supply operation state, when the roll-restraining force exerted by the corresponding stabilizer bar is in process of decrease.

The above-indicated form (5) limits the case in which the driver is placed into the above-indicated no-power-supply operation state and accordingly limits the case in which at least one of the drivers of the pair of stabilizer apparatus is placed in the phase-interconnection operation state. Where the vehicle performs one typical turning motion, for instance, the roll moment that acts on the vehicle body increases with a lapse of time at an initial period of the turning motion. Accordingly, there is executed a control to increase the roll restraining force exerted by the stabilizer bar. At a middle period of the turning motion, the roll moment is kept constant, and accordingly there is executed a control to keep the roll restraining force constant. In contrast, at a final period of the turning, the roll moment decreases, and accordingly there is executed a control to decrease the roll restraining force. Where the roll restraining force is in process of decrease as described above, there is executed a control in which the operational amount of the actuator from a neutral position (which is an operational position of the actuator when the vehicles is at a stop on a flat road, for instance) is decreased. However, because the actuator is in a state in which the external input force is applied thereto, the actuator is operated by the external input force without relying on power supply from the power source. In this instance, it is expected that the amount of the electric power to be consumed can be reduced. In any event, where the driver is placed in the no-power-supply operation state when the roll restraining force is in process of decrease, it is possible to decrease, by the external input force, the operational amount of the actuator, that is, the twisting amount of the stabilizer bar. The present form realizes the phase-interconnection operation state in the no-power-supply operation state in which the roll restraining force is being decreased. The power generation amount of the electric motor due to the external input force when the roll restraining force is in process of decrease is expected to be relatively large. Accordingly, the present form is particularly effective to reduce the load to be imposed on the driver and the load to be imposed on the power source because the driver is placed into the no-power-supply operation state when the roll restraining force is in process of decrease.

(6) The stabilizer system according to any one of the above forms (1)-(5),

wherein the stabilizer bar of each of the pair of stabilizer apparatus is constituted by including a pair of stabilizer bar members each of which includes a torsion bar portion disposed coaxially along an axis extending in a width direction of the vehicle and an arm portion which extends continuously from the torsion bar portion so as to intersect the torsion bar portion and which is connected at a leading end thereof to the corresponding wheel holding member, and

wherein the actuator of each of the pair of stabilizer apparatus is operable to rotate the torsion bar portions of the pair of stabilizer bar members relative to each other

In the above-indicated form (6), the structure of the stabilizer apparatus, in detail, the structure of the stabilizer bar and the actuator is specifically limited. According to the present form, the roll restraining force to be exerted by the stabilizer bar can be efficiently changed.

(7) The stabilizer system according to the above form (6),

wherein the actuator of each of the pair of stabilizer apparatus further includes a decelerator for decelerating rotation of the corresponding electric motor and a housing which holds the decelerator and the electric motor, and

wherein the torsion bar portion of one of the pair of stabilizer bar members is connected to the housing so as to be unrotatable relative to the housing while the torsion bar portion of the other of the pair of stabilizer bar members is connected to an output portion of the decelerator so as to be unrotatable to the output portion.

In the above-indicated form (7), the structure of the actuator and the connection and layout of the actuator and the stabilizer bar are specifically limited. The mechanism of the decelerator of the actuator in the present form is not particularly limited. It may be possible to employ a decelerator with various mechanisms such as a harmonic gear mechanism called “HARMONIC DRIVE”™ mechanism or a strain wave gear ring mechanism, and a planetary gear mechanism. For the size reduction of the electric motor, it is desirable that the decelerator have a large reduction gear ratio. (In this connection, the large reduction gear ratio means a small operational amount of the actuator with respect to the operational amount of the electric motor.) Accordingly, the decelerator having the harmonic gear mechanism is suitably used in the system of the present form. Where the decelerator having a large reduction gear ratio is employed, a relatively large amount of the electric power is generated by the operation of the actuator due to the external input force. In this instance, it is anticipated that the load to be imposed on the driver or the load to be imposed on the power source will become large. Therefore, to place the driver into the phase-interconnection operation state is particularly advantageous for the actuator employing the decelerator with a large reduction gear ratio.

### BRIEF DESCRIPTION OF THE DRAWINGS

The above and other objects, features, advantages and technical and industrial significance of a claimable invention will be better understood by reading a following detailed description of a preferred embodiment of the invention, when considered in connection with the accompanying drawings, in which:

FIG. 1 is a schematic view showing an overall structure of a stabilizer system according to one embodiment of a claimable invention;

FIG. 2 is a schematic view showing a stabilizer apparatus of the stabilizer system of FIG. 1;

FIG. 3 is a schematic view in cross section showing an actuator of the stabilizer apparatus of FIG. 1:

FIG. 4 is a circuit diagram showing an inverter of the stabilizer system of FIG. 1;

FIG. 5 is a view schematically showing a state of the inverter in the circuit diagram of FIG. 4 in which an electric current based on power generated by an electric motor flows back toward a converter;

FIG. 6 is a table showing changing patterns of an electrified phase established by the inverter of FIG. 4 in respective operation modes of the electric motor;

FIG. 7 is a view schematically showing a state in which the inverter shown in the circuit diagram of FIG. 4 is in a phase-interconnection operation state;

FIG. 8 is a flow chart showing a stabilizer-control program executed in the stabilizer system of FIG. 1;

FIG. 9 is a flow chart showing an operation-mode determining sub routine executed in the stabilizer-control program; and

FIG. 10 is a block diagram showing functions of a stabilizer electronic control unit (ECU) as a control device.

### DETAILED DESCRIPTION OF THE PREFERRED EMBODIMENT

There will be described in detail one embodiment of the claimable invention, referring to the drawings. It is to be understood, however, that the invention is not limited to the following embodiment, but the invention may be embodied with various changes and modifications, such as those described in the FORMS OF THE INVENTION, which may occur to those skilled in the art.

### 1. Overall Structure of Stabilizer System

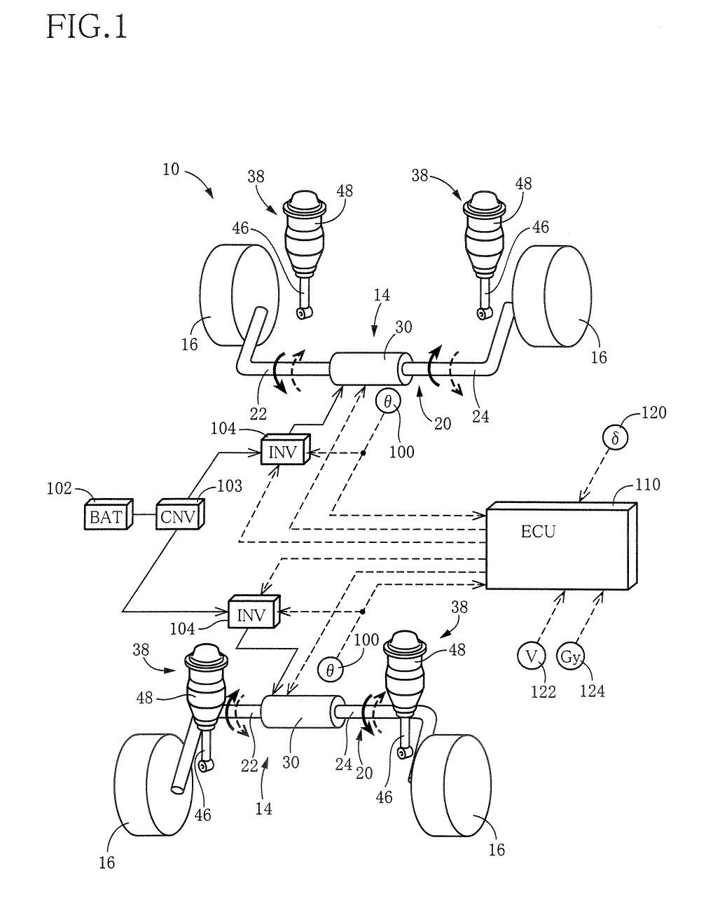

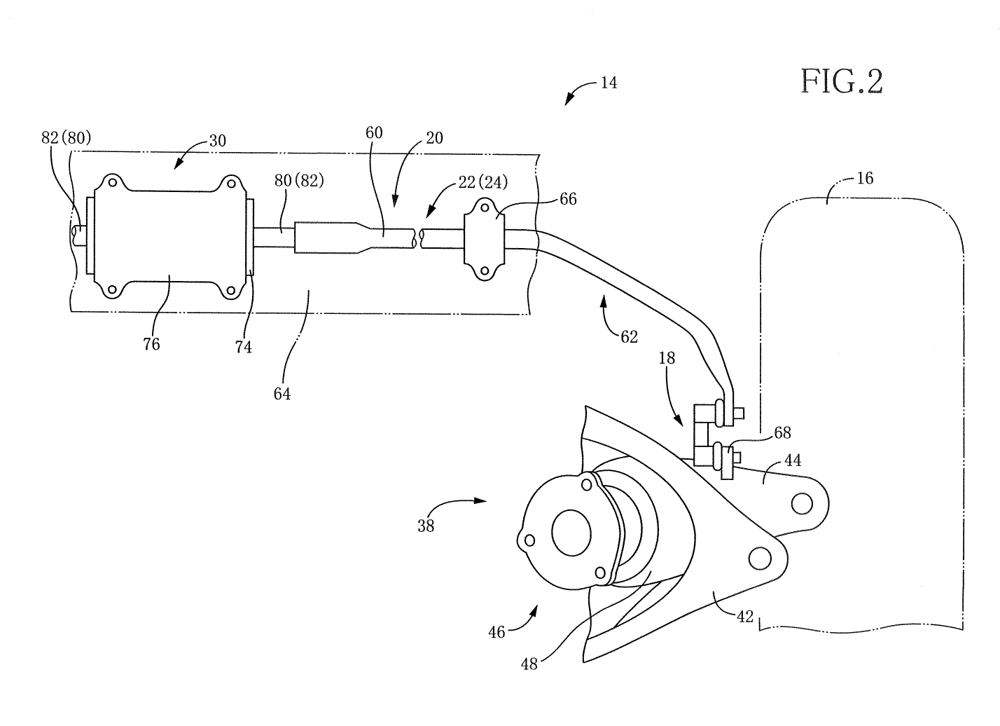

FIG. 1 conceptually shows a stabilizer system 10 for a vehicle according to one embodiment of the claimable invention. The stabilizer system 10 includes two stabilizer apparatus 14 one of which is disposed on a front-wheel side of the vehicle and the other of which is disposed on a rear-wheel side of the vehicle. Each stabilizer apparatus 14 includes a stabilizer bar 20 connected at opposite ends thereof, via respective link rods 18 each as a connecting member, to respective wheel holding members (FIG. 2) which respectively hold front and rear wheels 16. The stabilizer bar 20 is divided at a middle portion thereof into two parts, i.e., a right stabilizer bar member 22 and a left stabilizer bar member 24. The pair of stabilizer bar members 22, 24 are connected rotatably relative to each other with an actuator 30 interposed therebetween. Roughly speaking, the stabilizer apparatus 14 is arranged such that the actuator 30 rotates the right and left stabilizer bar members 22, 24 relative to each other (as shown in arrows indicated by solid line and arrows indicated by broken line in FIG. 1), thereby changing apparent stiffness of the stabilizer bar 20 as a whole, for restraining rolling of the vehicle body.

FIG. 2 schematically shows a portion of the stabilizer apparatus 14 ranging from its middle part in a widthwise direction of the vehicle to a wheel 16 on one of the right-side and the left-side of the vehicle. The vehicle on which the present stabilizer system 10 is installed includes four independent suspension apparatus 38 provided respectively for the four wheels 16. Each suspension apparatus 38 is of a double wishbone type well known in the art and includes an upper arm 42 and a lower arm 44 each of which functions as the wheel holding member. Each of the upper and lower arms 42, 44 is rotatably connected at one end thereof to the vehicle body and connected at the other end thereof to the corresponding wheel 16. Each of the upper and lower arms 42, 44 is pivotably moved or swung about the above-indicated one end (vehicle-body-side end) while the other end (wheel-side end) is moved generally in the vertical direction relative to the vehicle body, as the corresponding wheel 16 and the vehicle body approach toward and remove away from each other (namely, as the wheel 16 and the vehicle body move relative to each other in the vertical direction). The suspension apparatus 38 further includes a shock absorber 46 and a suspension spring 48 (which is an air spring in the present embodiment). Each of the shock absorber 46 and spring 48 is connected at one end thereof to a mount portion of the vehicle body and at the other end thereof to the lower arm 44. The thus constructed suspension apparatus 38 elastically supports the corresponding wheel 16 and the vehicle body and has a function of generating a damping force with respect to a vibration which is accompanied by the relative displacement between the wheel 16 and the vehicle body toward and away from each other.

The stabilizer apparatus 14 includes the pair of stabilizer bar members, i.e., the right stabilizer bar member 22 and the left stabilizer bar member 24. (In FIG. 2, one of the right and left stabilizer bar members 22, 24 is shown.) Each of the right and left stabilizer bar members 22, 24 includes: a torsion bar portion 60 extending substantially in the vehicle width direction; and an arm portion 62 formed integrally with the torsion bar portion 60 and intersecting the same 60 so as to extend generally in a frontward or a rearward direction of the vehicle. The torsion bar portion 60 of each stabilizer bar member 22, 24 is rotatably supported, at a position thereof near to the arm portion 62, by a support member 66 which is fixedly disposed at a stabilizer-apparatus mounting portion 64 that is a part of the vehicle body. Thus, the torsion bar portions 60 of the respective right and left stabilizer bar members 22, 24 are disposed coaxially relative to each other. Between respective ends of the torsion bar portions 60 of the right and left stabilizer bar members 22, 24, which ends are located near to a widthwise middle portion of the vehicle, the actuator 30 indicated above is disposed. As explained below in detail, the respective ends of the torsion bar portions 60 are connected to the actuator 30. In the meantime, one end of each arm portion 62 remote from the corresponding torsion bar portion 60 is connected to a stabilizer-bar connecting portion 68 of the corresponding lower arm 44 via the corresponding link rod 18.

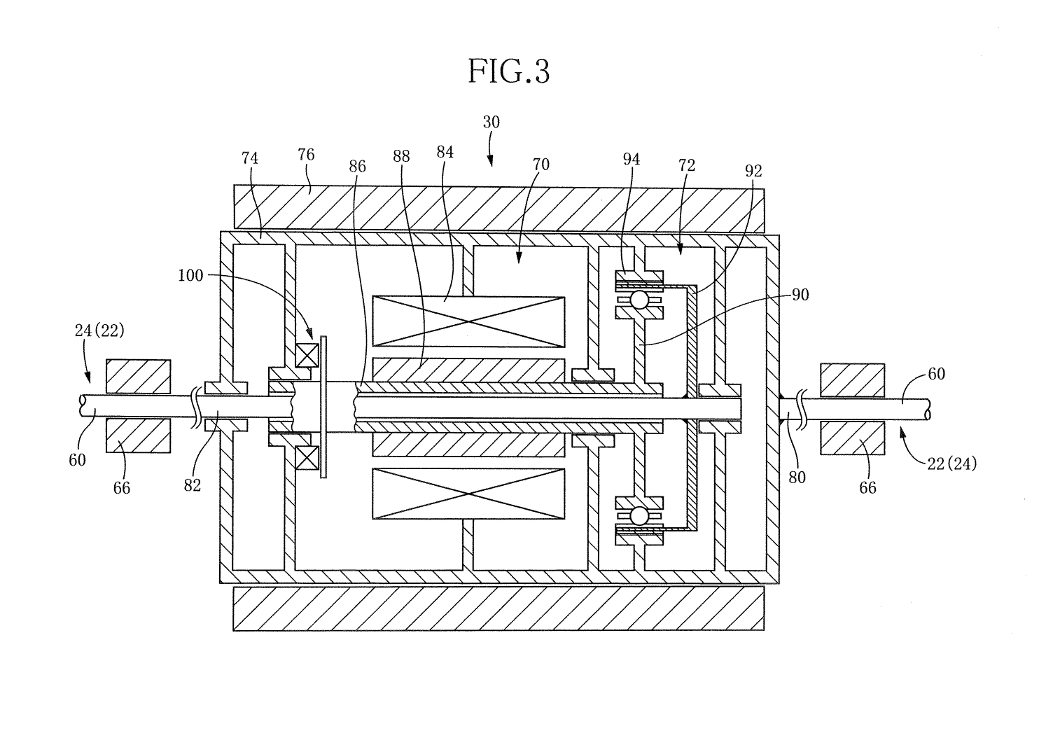

As schematically shown in FIG. 3, the actuator 30 includes an electric motor 70 and a decelerator 72 connected to the electric motor 70 for decelerating rotation of the electric motor 70. The electric motor 70 and the decelerator 72 are disposed inside a housing 74 as an outer frame member of the actuator 30. The housing 74 is held, at the stabilizer-apparatus mounting portion 64 provided on the vehicle body, by a housing holding member 76 so as to be rotatable and immovable in the axial direction (i.e., substantially in the vehicle width direction) relative to the hosing holding member 76. As apparent from FIG. 2, two output shafts 80, 82 extend respectively from opposite ends of the housing 74. The output shafts 80, 82 are unrotatably connected by serration engagement, at their leading ends remote from the housing 74, respectively to ends of the respective right and left stabilizer bar members 22, 24. Further, as shown in FIG. 3, one 80 of the two output shafts 80, 82 is fixedly connected to one of the opposite ends of the housing 74 while the other 82 of the two output shafts 80, 82 is disposed so as to extend into the housing 74 and is held by the housing 74 so as to be rotatable and axially immovable relative to the same 74. One end of the output shaft 82 located within the housing 74 is connected to the decelerator 72 as explained below in detail. The output shaft 82 functions also as an output portion of the decelerator 72. In the following description, where it is not necessary to distinguish the two stabilizer apparatus 14, the two electric motors 70, the two actuators 30, etc., from each other, the stabilizer apparatus 14, the electric motor 70, the actuator 30, etc., will be referred simply to as “the stabilizer apparatus 14”, “the electric motor 70”, “the actuator 30”, etc.

The electric motor 70 includes: a plurality of stator coils 84 fixedly disposed on one circumference along an inner circumferential surface of the cylindrical wall of the housing 74; a hollow motor shaft 86 rotatably held by the housing 74; and permanent magnets 88 fixedly disposed on one circumference along an outer circumferential surface of the motor shaft 86 so as to face the stator coils 84. The electric motor 70 is a motor in which the stator coils 84 function as a stator and the permanent magnets 88 function as a rotor, and is a three-phase DC brushless motor.

In the present embodiment, the decelerator 72 is constituted as the harmonic gear mechanism including a wave generator 90, a flexible gear 92, and a ring gear 94. The wave generator 90 includes an oval cam and ball bearings fitted on a periphery of the cam, and is fixed to one end of the motor shaft 86. The flexible gear 92 is a cup-like member whose cylindrical wall portion is elastically deformable. A plurality of teeth are formed on an outer circumference of the open end portion of the cup-like flexible gear 92. The flexible gear 92 is connected to the output shaft 82 described above and is held by the same 82. In detail, the output shaft 82 penetrates the motor shaft 86 and has an end portion extending from or beyond the one end of the motor shaft 86. To this end portion of the output shaft 82, a bottom portion of the flexible gear 92 is fixed with the end portion penetrating the bottom portion, whereby the flexible gear 92 and the output shaft 82 are connected to each other. The ring gear 94 is a generally ring-like member and is fixed to the housing 74. A plurality of teeth are formed on an inner circumference of the ring gear 94. The number of teeth formed on the inner circumference of the ring gear 94 is slightly larger (e.g., larger by two) than the number of teeth formed on the outer circumference of the flexible gear 92. The flexible gear 92 is fitted at its cylindrical wall portion on the wave generator 90, and is elastically deformed into an oval shape. The flexible gear 92 meshes the ring gear 94 at two portions thereof corresponding to opposite ends of the long axis of the oval and does not mesh the same 94 at the other portion thereof. With one rotation of the wave generator 90 (i.e., after rotation of the wave generator 90 by 360°), in other words, after one rotation of the motor shaft 86 of the electric motor 70, the flexible gear 92 and the ring gear 94 are rotated relative to each other by an amount corresponding to the difference in the number of teeth therebetween.

In the thus constructed stabilizer apparatus 14, where the vehicle body undergoes, due to turning of the vehicle or the like, force which changes the distance between one of the right and left wheels 16 and the vehicle body and the distance between the other of the right and left wheels 16 and the vehicle body, relative to each other, i.e., the roll moment, the actuator 30 receives force acting thereon which rotates the right stabilizer bar members 22 and the left stabilizer bar member 24 relative to each other, i.e., the external input force. In this instance, when the actuator 30 exerts, as actuator force, force which is in balance with the external input force, owing to motor force that is generated by the electric motor 70, one stabilizer bar constituted by the right and left stabilizer bar members 22, 24 is twisted. (The above-indicated motor force may be hereinafter referred to as “rotational torque” because the electric motor 70 is a rotation motor and therefore the force generated by the electric motor 70 is considered as rotational torque.) Elastic force generated by the twisting of the stabilizer bar 20 functions as counter force with respect to the roll moment, i.e., the roll restraining force. By changing, owing to the motor force, a relative rotational position of the output shafts 80, 82 of the actuator 30, namely, by changing a rotational position (an operational position) of the actuator 30, a relative rotational position of the right and left stabilizer bar members 22, 24 is changed, whereby the above-indicated roll restraining force is changed. Consequently, the roll amount of the vehicle body can be changed. The present stabilizer apparatus 14 is arranged such that the apparent stiffness of the stabilizer bar 20, i.e., the stabilizer stiffness, is changeable.

The actuator 30 is provided, in the housing 74, with a motor-rotational-angle sensor 100 for detecting a rotational angle of the motor shaft 86, i.e., a rotational angle of the electric motor 70. The motor-rotational-angle sensor 100 of the present actuator 30 is constituted principally by an encoder. A value detected by the sensor 100 is utilized in the control of the actuator 30, that is, in the control of the stabilizer apparatus 14, as an index indicating a relative rotational angle (the relative rotational position) of the right and left stabilizer bar members 22, 24, in other words, as an index indicating the operational position (the rotational position) of the actuator 30.

To the electric motor 70 of the actuator 30, there is supplied electric power from a battery 102 (shown as “BAT” in FIG. 1). The present stabilizer system 10 is provided with a DC-DC converter 103 for raising the voltage to be supplied from the battery 102. The DC-DC converter 103 is shown as “CNV” in FIG. 1 and hereinafter may be simply referred to as “converter”. An electric power source is constituted by including the battery 102 and the converter 103. In the present stabilizer system 10, an inverter 104 (shown as “INV” in FIG. 1) is provided between the converter 103 and each of the two stabilizer apparatus 14. Each of the inverters 104 functions as a driver. The electric power is supplied to the electric motors 70 of the respective two stabilizer apparatus 14 via the respective two inverters 104. Because each electric motor 70 is driven at a constant voltage, the amount of electric power to be supplied is changed by changing the amount of electric current to be supplied, and each electric motor 70 exerts or generates force in accordance with the amount of electric current supplied thereto. In this respect, the amount of electric current to be supplied is changed such that a ratio (duty ratio) of a pulse-on time to a pulse-off time by PWM (Pulse Width Modulation) is changed by the inverters 104.

As shown in FIG. 1, the present stabilizer system 10 includes a stabilizer electronic control unit (ECU) 110 (hereinafter may be simply referred to as “the ECU 110”) as a control device for controlling the operation of each stabilizer apparatus 14, in detail, the operation of each actuator 30. The ECU 110 is constituted principally by a computer including a CPU, a ROM, a RAM, etc. To the ECU 110, there are connected, in addition to the aforementioned motor-rotational-angle sensor 100, an operation-angle sensor 120 for detecting an operation amount of a steering operating member as a steering amount, i.e., for detecting an operation angle of a steering wheel, a vehicle-speed sensor 122 for detecting a running speed of the vehicle (hereinafter may be simply referred to as “vehicle speed”), and a lateral-acceleration sensor 124 for detecting actual lateral acceleration which is lateral acceleration actually generated in the vehicle. In FIG. 1, these sensors 100, 120, 122, 124 are shown as θ, ä, v and Gy, respectively. The ECU 110 is connected also to each of the inverters 104, whereby the ECU 110 controls the rotational position of each actuator 30 by controlling each inverter 104. In the ROM of the computer of the ECU 110, there are stored a stabilizer control program and various data relating to the control of the stabilizer apparatus 14, etc., which will be explained.

### 2. Structure of Inverter

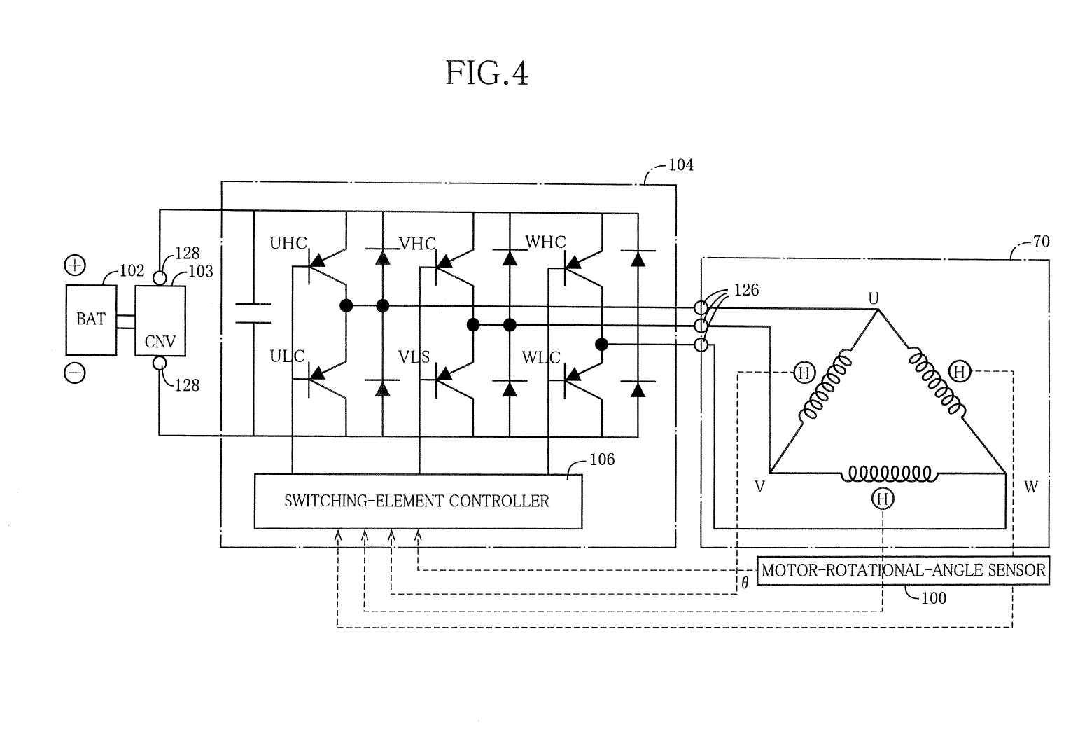

As shown in FIG. 4, each electric motor 70 is a delta-connected, three-phase, DC brushless motor. Each inverter 104 has two switching elements, i.e., a high-side (high-voltage-side) switching element and a low-side (low-voltage-side) switching element, for each of the three phases (U, V, W) of the electric motor 70. The high-side switching element and the low-side switching element may be also referred to as a positive-side switching element and a negative-side switching element, respectively. Hereinafter, the six switching elements of the inverter 104 will be referred to as “UHC”, “ULC”, “VHC”, “VLC”, “WHC”, and “WLC”, respectively. A switching-element controller 106 judges a rotational angle (an electric angle) based on signals detected by respective three Hall elements H_{A}, H_{B}, H_{C} provided in the electric motor 70 and outputs, based on the rotational angle, control signals to the six switching elements. The ON/OFF states of the respective six switching elements are changed in accordance with the control signals. In the present stabilizer system 10, electrical connection/disconnection between a terminal 126 of each phase of the electric motor and terminals (negative-side and positive-side terminals, in other words, high-voltage-side and low-voltage-side terminals) 128 of the electric power source is changed by changing the pattern of the ON/OFF states of the switching elements of the inverter 104 while the power-supply state of the electric power to the electric motor 70 is changed. Thus, the operation of the electric motor 70 is controlled.

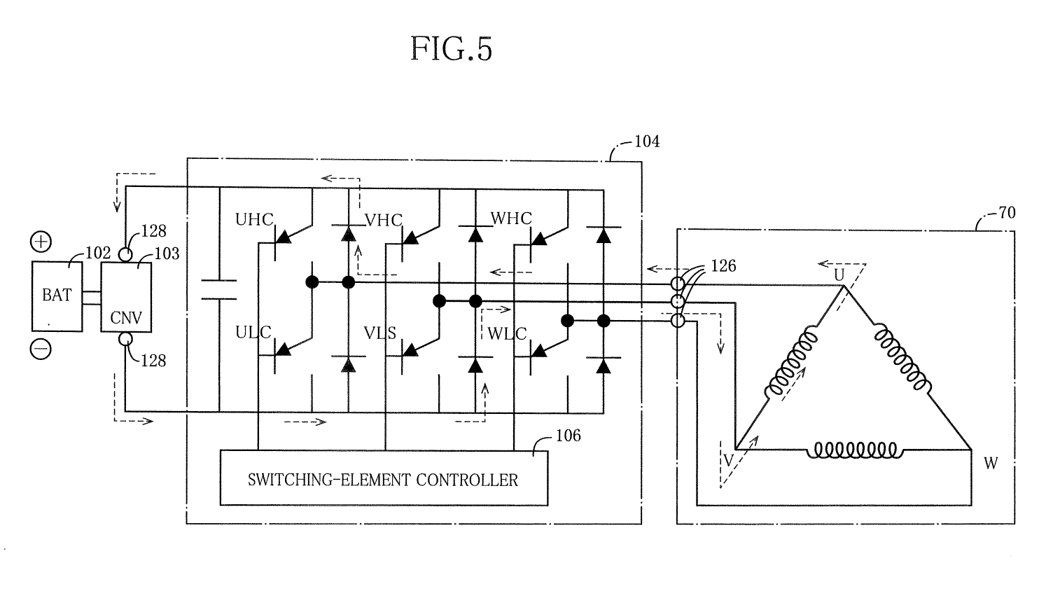

As explained above, the electric motor 70 is operated even by the external input force. For instance, when the electric motor 70 is operated by the external input force with no electric power supplied thereto from the power source, the electric motor 70 functions as an electric generator and generates electric power. Here, because the inverter 104 includes a plurality of reflux diodes each of which is disposed in parallel with a corresponding one of the switching elements, the electric current base on the power generated by the electric motor 70 may flow back toward the converter 103 through the reflux diodes. For instance, when the electric motor 70 generates electric power with all of the switching elements placed in the OFF state as shown in FIG. 5, there may be generated electric current which flows toward the converter 103 through the reflux diodes as indicated by arrows in broken line. The converter 103 is configured to inhibit the electric current from flowing toward the battery 102. Accordingly, if the voltage of an output portion of the converter 103 is raised due to such electric current, not only the converter 103 per se, but also the switching elements, may suffer from a load. Moreover, in the present stabilizer system 10, the battery 102 and the converter 103 are commonly used for the two stabilizer apparatus 14 on the front-wheel side and the rear-wheel side of the vehicle. Accordingly, if the two electric motors 70 of the respective two stabilizer apparatus 14 generate electric power at the same time, the voltage in the output portion of the converter 103 is further raised, so that a significantly large load may be imposed on the two inverters 104 of the respective two stabilizer apparatus

While the above description is made for the inverter that employs so-called bipolar transistors, the same goes for an inverter that employs MOS-type FET. The MOS-type FET per se includes reflux diodes. Accordingly, when the electric motor 70 generates electric power by the external input force, the generated electric current may flow back toward the converter, even in the inverter employing the MOS-type FET, thereby imposing a load on the converter and a load on the switching elements.

### 3. Relationship between Operation Mode of Electric Motor and Operation State of Inverter

i) Operation Mode of Electric Motor

In the present stabilizer system 10, the electric motor 70 of the actuator 30 of each stabilizer apparatus 14 is arranged to be operable in three operation modes, i.e., a control mode, a free mode, and a braking mode, which will be explained in detail. The electric motor 70 is operated in one of the three operation modes selected on the basis of predetermined conditions.

More specifically explained, in the control mode, the electric motor 70 permits the stabilizer bar to generate the roll restraining force in accordance with the roll moment while changes the stabilizer stiffness, whereby the roll restraining effect of the vehicle body can be actively controlled in accordance with the roll moment, etc., for instance. In the free mode, the roll restraining force is hardly generated. In the braking mode, the electric motor 70 is unlikely to be rotated by the external input force, thereby maintaining the roll restraining force at a certain level. Each of the three operation modes of the electric motor 70 and the operation state of the inverter in each operation mode will be explained in detail.

### (A) Control Mode

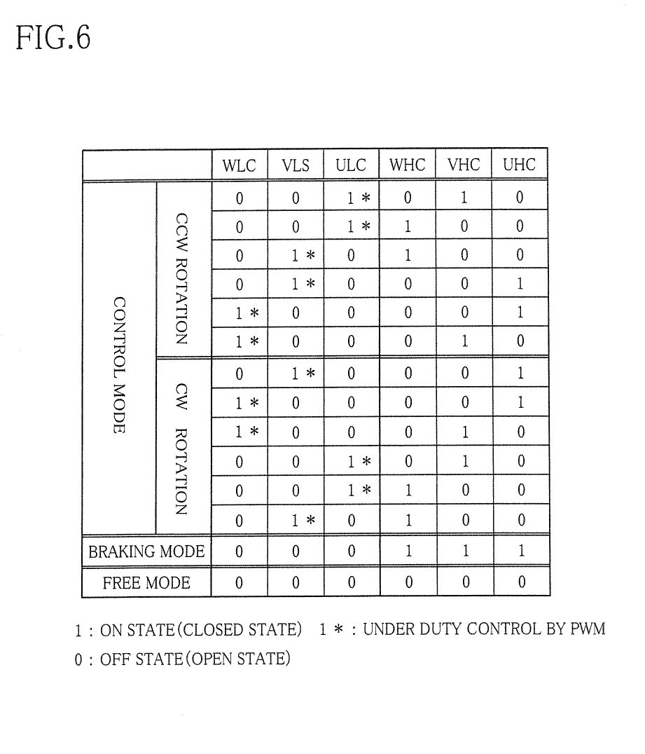

The control mode is an operation mode wherein a motor-phase-connecting formation is a formation in which the operation of the electric motor 70 is controllable and wherein electric power is supplied to the electric motor 70. The motor-phase-connecting formation means a formation relating to changing of the phases of the motor in supplying electric power from the electric power source to the motor, connection between the terminals 126 of the respective phases of the motor and the power source, interrelation among the terminals 126 of the respective phases, etc. In the control mode, according to a system called 120° rectangular-wave drive system, the ON/OFF states of the respective switching elements UHC, ULC, VHC, VLC, WHC, WLC are changed depending upon the rotational angle of the electric motor 70. Described more specifically, the phase of the electric motor 70 to be electrified (the electrified phase) is changed for every 60° of an electric angle, as shown in FIG. 6. In the control mode, as shown in FIG. 6, a change pattern of the electrified phase of the electric motor 70 differs depending upon a direction of generation of the motor force, i.e., a torque generating direction which is a direction of generation of the rotational torque. By selecting a suitable one of the changing patterns, the torque generating direction of the electric motor 70 is determined. In this respect, in the following explanation, the torque generating direction is expediently referred to as a clockwise (CW) direction and a counterclockwise (CCW) direction. In the control mode, only the switching elements ULC, VLC, WLC on the low side are subjected to an ON/OFF control according to a duty ratio, i.e., a duty control. By changing the duty ratio, the amount of electric current to be supplied to the electric motor 70 is changed. Each symbol “*1” in FIG. 6 indicates a state in which those switching elements are under the duty control.

As explained above, in the control mode, the torque generating direction of the electric motor 70 and the amount of electric power supplied to the electric motor 70 are controllable. Accordingly, in the control mode, it is possible to generate, in an arbitrary direction, rotational torque whose magnitude corresponds to the amount of electric current supplied to the electric motor 70. Because the rotational direction and the operation amount of the actuator 30 can be controlled, it is possible to generate roll restraining force corresponding to roll moment, enabling active control of the stabilizer apparatus 14.

There may be possible to set a stand-by mode as one form of the control mode indicated above. In the stand-by mode, while the phase of the electric motor 70 to be electrified (the electrified phase) is changed in response to the command of the torque generating direction, no electric power is supplied from the power source. More specifically explained, the ON/OFF states of the respective switching elements UHC, ULC, VHC, VLC, WHC, WLC are changed in accordance with the rotational angle of the electric motor 70. However, the duty control is kept unexecuted in any of the switching elements UHC, VHC, WHC on the high side and the switching elements ULC, VLC, WLC on the low side. (It may be said that the duty control is performed such that the duty ratio is made zero.) Namely, in the stand-by mode, there exist no pulse-on times, and no electric power is actually supplied to the electric motor 70.

### (B) Free Mode

In the free mode, the motor-phase-connecting formation is a formation in which electric power is inhibited from being supplied to the phases of the electric motor 70. In the free mode, the terminals 126 of the respective phases of the electric motor 70 are disconnected from each other. More specifically described, all of the switching elements are placed in the OFF state, as shown in FIG. 6. FIG. 5 illustrates the inverter 104 whose switching elements are all kept in the OFF state. Where the free mode is employed, no electric power is supplied from the power source to the electric motor 70, so that the stabilizer bar 20 is kept in a state in which force to be exerted by the stabilizer bar 20, in detail, resistance force with respect to the external input force, is comparatively small. In the free mode, all of the switching elements are kept in the OFF state. However, since there is formed a current path passing through the reflux diodes which are provided parallel with the respective switching elements, the electric motor 70 may generate electric power when the actuator 30 is operated by the external input force and the electric current based on the electric power generated by the electric motor 70 may flow back toward the converter 103. The stabilizer bar 20 exerts the resistance force with respect to the external input force by the magnitude corresponding to the amount of the generated electric power.

(iii) Braking Mode

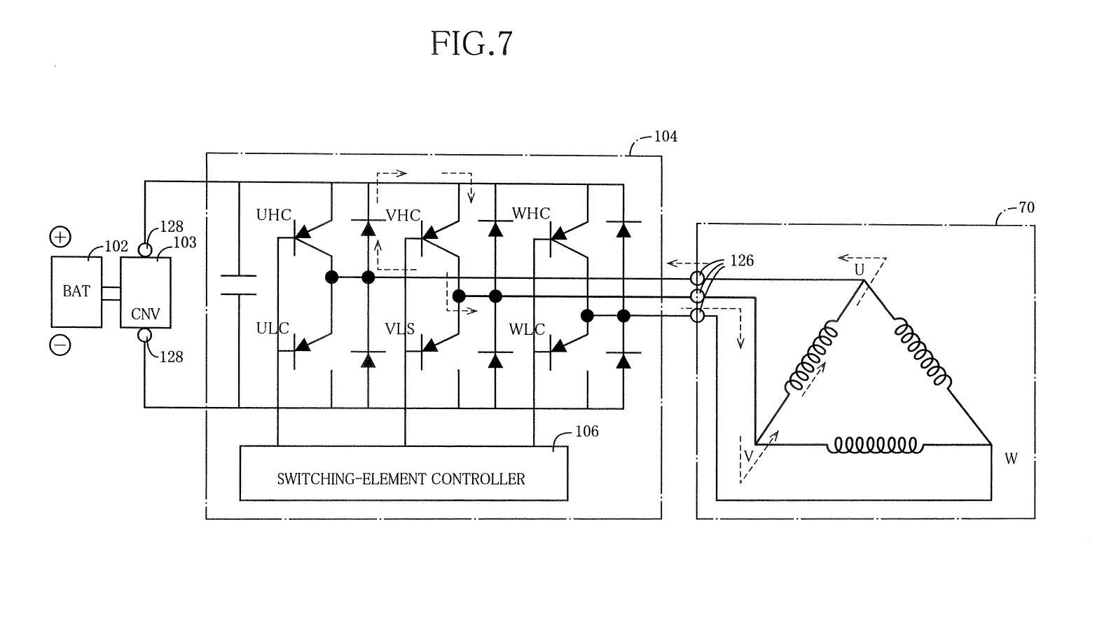

In the braking mode, the motor-phase-connecting formation is a formation in which the terminals 126 of the respective phases of the electric motor 70 are connected to each other. Described more specifically, all of the switching elements that are disposed on one of the high side and the low side are placed in the ON state and all of the switching elements that are disposed on the other of the high side and the low side are placed in the OFF state. In the present embodiment, as shown in FIG. 6, all of the switching elements UHC, VHC, WHC on the high side are placed in the ON state while all of the switching elements ULC, VLC, WLC on the low side are placed in the OFF state. FIG. 7 illustrates the inverter 104 whose switching elements are kept in that state. Owing to these switching elements UHC, VHC, WHC placed in the ON state and the reflux diodes disposed together with the respective switching elements, the phases of the electric motor 70 are kept as if they were short-circuited to each other, that is, kept in the phase-interconnection operation state. In such a state, there is given a so-called short-circuiting breaking effect to the electric motor 70. Accordingly, when the actuator 30 is compelled to be operated at a high speed by the external input force, the actuator 30 exerts relatively large resistance against the operation thereof, so that the stabilizer apparatus 14 is placed into a state close to a conventional stabilizer apparatus in which the stabilizer stiffness is not changeable. Where the control according to the braking mode is executed, the electric power generated by the electric motor 70 as a result of the operation of the actuator 30 by the external input force is consumed within the electric motor 70, avoiding imposition of the load on the inverter 104 and the converter 103.

ii) Two Principal Operation States of Driver

The operation state of the inverter 104 for enabling the electric motor 70 to be operated in the above-indicated three operation modes are classified generally into two operation states. One of them is a power-supply operation state in which electric power is supplied to the electric motor 70. In the power-supply operation state, the amount of electric power to be supplied to the electric motor 70 is controlled while changing the phase of the electric motor 70 to be electrified (the electrified phase) in supplying the electric power to the motor 70, for thereby actively controlling the actuator 30. The other of the two operation states is a no-power-supply operation state in which no electric power is supplied to the electric motor 70. The no-power-supply operation state is divided into two sub operation states. One of the two sub operation states is an all-switching-element-OFF operation state in which all of the switching elements of the inverter 104 are placed in the OFF state. The other sub operation state is a one-side-switching-element-ON operation state in which all of the switching elements disposed on one of the high side and the low side are placed in the ON state while all of the switching elements disposed on the other of the high side and the low side are placed in the OFF state.

iii) Relationship Between Operation Mode of Electric Motor and Operation State of Driver

Among the above-indicated three operation modes of the electric motor 70, the control mode is executable basically by placing the inverter 104 in the power-supply operation state while the free mode and the braking mode are executable by placing the inverter 104 in the no-power-supply operation state. More specifically explained, where the control according to the free mode is executed, the inverter 104 is placed in the all-switching-element-OFF operation state. Where the control according to the braking mode is executed, the inverter 104 is placed in the one-side-switching-element-ON operation state. In this respect, where the stand-by mode explained above is executed, the control in which the duty ratio is zero is maintained, so that the operation state of the inverter 104 in the stand-by mode can be considered to be the no-power-supply operation state.

### 4. Control of Stabilizer Apparatus

i) Basic Control

In the present stabilizer system 10, the roll restraining force in response to the roll moment is generated and the stabilizer stiffness is changed, under the above-described control mode, whereby it is possible to actively control the effect of restraining rolling of the vehicle body in response to the roll moment, etc., for instance. On the other hand, where it is not necessary to execute the control according to the control mode and where it is desirable not to execute the control according to the control mode, there is executed one of the control under the free mode in which the roll restraining force is hardly generated and the control under the braking mode in which the resistance with respect to the operation of the actuator is imparted.

In the control according to the control mode, a target rotational position of the actuator 30 which is a target operational amount of the same 30 is determined based on a roll-moment index amount which is indicative of roll moment the vehicle body receives, for making twisting stiffness of the stabilizer bar 20 appropriate. Further, the rotational position of the actuator 30 is controlled so as to coincide with the determined target rotational position. Namely, on the basis of the roll-moment index amount, the actuator 30 is controlled such that the pair of stabilizer bar members 22, 24 in each stabilizer apparatus 14 are rotated relative to each other by a suitable angle for generating the roll restraining force that makes the roll amount of the vehicle body appropriate. Here, the rotational position of the actuator 30 means the following: A state in which no roll moment acts on the vehicle body is deemed as a normal state. Where the rotational position of the actuator 30 in the normal state is deemed as a neutral position, the rotational position of the actuator 30 indicates an amount of rotation from the neutral position. That is, the rotational position of the actuator 30 means a displacement amount of the operational position of the actuator 30 from the neutral position. Because there is a correspondence relationship between the rotational position of the actuator 30 and the motor rotational angle which is a rotational angle of the electric motor 70, the motor rotational angle is actually used in the active control, in place of the rotational position of the actuator 30.

The control according to the control mode will be explained in more detail. In the present embodiment, a target motor rotational angle è* as the target rotational position of the actuator 30 (which is one kind of the target operational amount) is determined on the basis of the lateral acceleration as the above-indicated roll-moment index amount. More specifically explained, there is determined, according to the following formula, control-use lateral acceleration Gy* to be utilized in the control, on the basis of: estimated lateral acceleration Gyc that is estimated based on the operation angle of the steering wheel and the vehicle running speed; and actual lateral acceleration Gyr that is actually measured:

Gy*=K₁·Gyc+K₂*Gyr

wherein K₁ and K₂ are gains. The target motor rotational angle è* is determined based on the thus determined control-use lateral acceleration Gy*. According to a feed-back control method based on deviation between the target motor rotational angle è* and an actual motor rotational angle è which is an actual motor rotational angle, a target supply current i* to be supplied to the motor 70 is determined. Namely, appropriate electric power is supplied to the electric motor 70 of the actuator 30 in an attempt to make the rotational position of the actuator 30 close to the target rotational position or maintain the rotational position of the actuator 30 at the target rotational position.
ii) Selection of Control

In the present stabilizer system 10, one of the controls according to the above-indicated three operation modes is selectively executed based on changes in the roll moment generated in the vehicle. More specifically explained, a suitable one of the operation modes is selected and the control according to the selected operation mode is executed, for a case in which the roll restraining force is increased or maintained, a case in which the roll restraining force is decreased, or a case in which the roll restraining force is made substantially zero. Hereinafter, there will be explained which one of the controls according to the three operation modes is executed for each of the above-indicated three cases, by taking one typical turning motion of the vehicle.

In one turning motion of the vehicle, the roll moment which acts on the vehicle increases with a lapse of time at an initial period of turning of the vehicle while the roll moment is kept constant at a middle period of turning. Accordingly, during the initial and the middle periods of turning, the control according to the control mode is executed for increasing or maintaining the roll restraining force. At a final period of turning in which the roll moment decreases, there is executed a control to decrease the roll restraining force exerted by the stabilizer bar 20. Where the roll restraining force of the stabilizer bar 20 is decreased, the present stabilizer system 10 alternately executes the control according to the free mode and the control according to the braking mode. In the control according to the free mode, the actuator 30 is permitted to be rotated in a direction in which the roll restraining force decreases (i.e., in a direction toward the neutral position) owing to the external input force. In the control according to the braking mode, the actuator 30 is unlikely to be rotated. More specifically explained, the electric motor 70 is rotated together with the actuator 30 in accordance with a decrease in the roll moment as a result of execution of the control according to the free mode. However, when the actual motor rotational angle è of the electric motor 70 becomes close to the target motor rotational angle è*, the operation mode of the electric motor 70 is changed from the free mode to the braking mode, whereby the actual motor rotational angle è is prevented from becoming excessively small with respect to the target motor rotational angle è*.

More specifically, the operation mode of the electric motor 70 is changed between the free mode and the braking mode depending upon an amount of motor-rotational-angle deviation Äè(=è è*) which is deviation of the actual motor rotational angle è of the electric motor 70 from the target motor rotational angle è*. Namely, where the motor-rotational-angle deviation Äè is large, the control according to the free mode is executed, thereby permitting the actuator 30 to be rotated toward the neutral position. On the other hand, where the motor-rotation-angle deviation Äè is small, the control according to the braking mode is executed to prevent the actual motor rotational angle è from becoming smaller than the target motor rotational angle è*.

Where the vehicle is not in the turning motion such as when the vehicle is running substantially straightforward or when the vehicle is at a stop and therefore the roll moment generated in the vehicle is substantially zero, the actuator 30 is maintained at the neutral position. More specifically, the control according to the braking mode is executed in a state in which the actual motor rotational angle è is generally zero. (In this respect, the motor rotational angle corresponding to he neutral position of the actuator 30 is expediently determined to be zero.)

iii) Under-Both-Driver-No-Power-Supply-State Control

In the present stabilizer system 10, where the roll restraining force is decreased at the final period of the turning motion of the vehicle, one of the braking mode and the free mode is selected and the control according to the selected mode is executed. Namely, where the roll restraining force is decreased, the operation state of the inverter 104 is placed in the no-power-supply operation state. In most cases, the roll restraining force is decreased in both of the stabilizer apparatus 14 on the front-wheel side and the rear-wheel side, both of the inverters 104 are placed in the no-power-supply operation state. Where the free mode is selected, the electric motor 70 generates the electric power by the external input force and the electric current based on the generated power flows back toward the converter 103. Where the control according to the free mode is executed for both of the electric motors 70, the electric current based on the power generated by both of the electric motors 70 flows back toward the converter 103, imposing a considerably large load on the converter 103 and the inverters 104.

To avoid imposition of an excessively large load on the converter 103 and the inverters 104, the present stabilizer system 10 is arranged such that the operation mode of either one of the two electric motors 70 is forcibly placed into the braking mode where the control according to the free mode is executed for both of the electric motors 70 at the same time. Namely, there is executed a control to inhibit the control according to the free mode from being executed for the two electric motors 70 at the same time. In detail, where it is judged that the operation mode of either one of the two electric motors 70 should be placed in the free mode, there is executed processing of confirming the operation mode of the other electric motor 70. Where the control according to the free mode is under execution for the other electric motor 70, there is executed the under-both-driver-not-power-supply-state control in which the operation mode of the above-indicated one of the two electric motors 70 is forcibly placed into the braking mode.

By execution of the above-indicated under-both-driver-no-power-supply-state control, the operation mode of at least one of the two electric motors 70 of the respective two stabilizer apparatus 14 is placed into the braking mode where the operation state of both of the inverters 104 is in the no-power-supply operation state. According to the arrangement, even when the electric motor 70 under execution of the control according to the braking mode generates electric power by the external input force, the generated power is consumed within the electric motor 70 in question. It is, therefore, possible to obviate concurrent backflow of the generated power from both of the electric motors 70 toward the converter 103, thus preventing imposition of an excessively large load on the converter 103 and the inverter 104.

In the stabilizer apparatus 14 in which the above-indicated stand-by mode is set as one type of the control mode, it may be possible to execute the under-both-driver-no-power-supply-state control explained above where both of the electric motor 70 on the front-wheel side and the electric motor 70 on the rear-wheel side are controlled under either one of the stand-by mode and the free mode.

### 5. Stabilizer Control Program

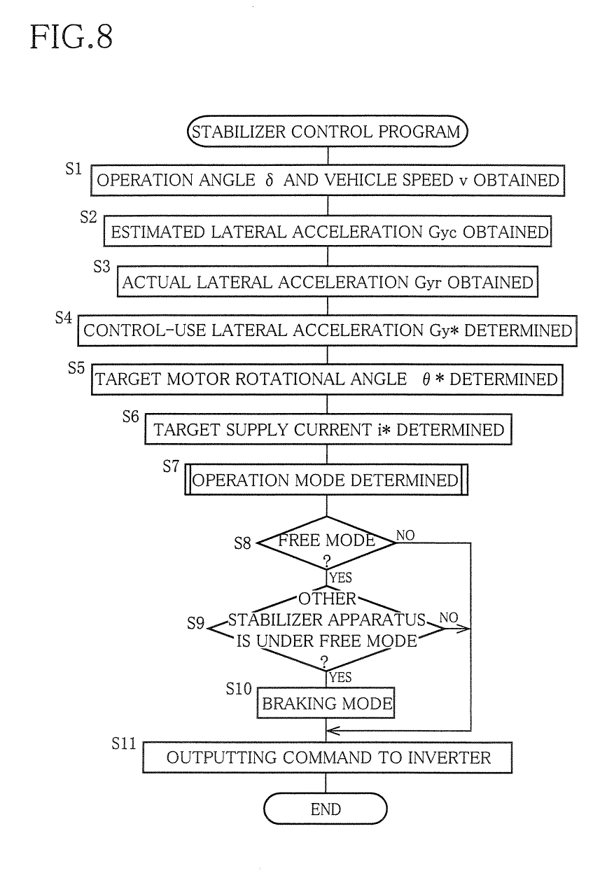

The control of the present stabilizer system 10 is carried out such that a stabilizer control program shown in a flow chart of FIG. 8 is repeatedly implemented by the ECU 110 at short time intervals (e.g., several milliseconds) with an ignition switch of the vehicle placed in an ON state. The flow chart of FIG. 8 is a program to be executed for one of the stabilizer apparatus 14 on the front-wheel side and the stabilizer apparatus 14 on the rear-wheel side. Actually, the program is executed for each of the two stabilizer apparatus 14 on the front-wheel side and the rear-wheel side. Hereinafter, there will be explained in detail a flow of the stabilizer control referring to the flow chart. The following explanation is made in common for the two stabilizer apparatus 14 on the front-wheel side and the rear-wheel side, in the interest of brevity.

In the stabilizer control program, step S1 (hereinafter “step” is omitted where appropriate) is initially implemented to obtain a vehicle speed v and an operation angle ä based on values detected by the vehicle-speed sensor 122 and the steering-angle sensor 120, respectively. Next, S2 is implemented to obtain estimated lateral acceleration Gyc based on the vehicle speed v and the operation angle ä obtained in S1. In the ECU 110, there is stored map data which relates to estimated lateral acceleration Gyc and which uses vehicle speed v and operation angle ä as parameters. The estimated lateral acceleration Gyc is obtained by referring to the map data. Subsequently, in S3, there is obtained actual lateral acceleration Gyr that is lateral acceleration actually generated in the vehicle body, on the basis of a value detected by the lateral-acceleration sensor 124. Next, in S4, control-use lateral acceleration Gy* is determined based on the estimated lateral acceleration Gyc and the actual lateral acceleration Gyr. S4 is followed by S5 in which a target motor rotational angle è* is determined based on the control-use lateral acceleration Gy*. In the ECU 110, there is stored map data of target rotational angle è* which uses control-use lateral acceleration Gy* as a parameter. The target motor rotational angle è* is determined in S5 referring to the map data. Then, S6 is implemented to determine a target supply current i* on the basis of motor-rotational-angle deviation Äè which is deviation between the target motor rotational angle è* and the actual motor rotational angle è.

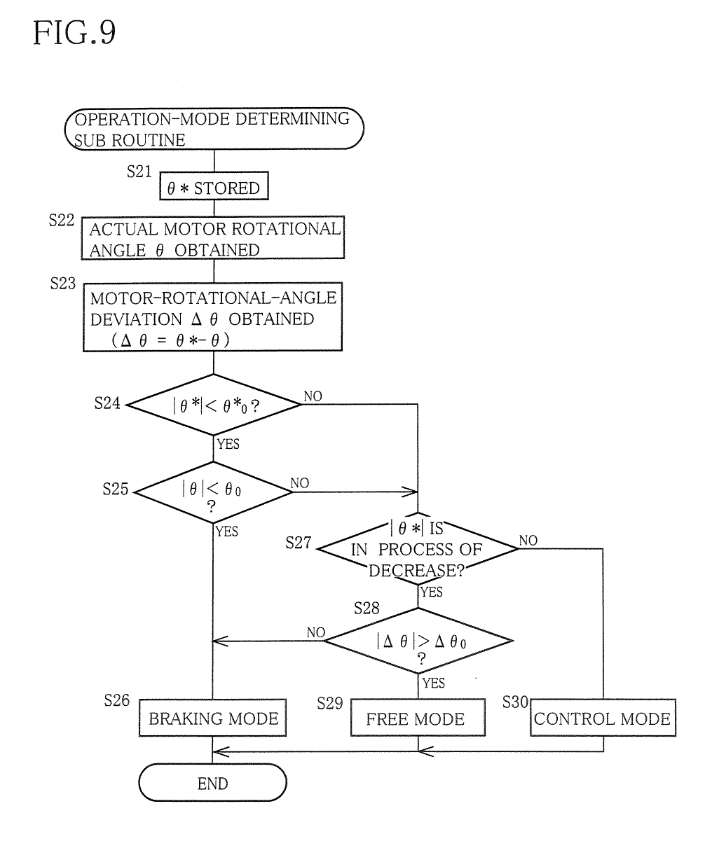

S6 is followed by S7 in which is implemented an operation-mode determining sub routine shown in a flow chart of FIG. 9. In the sub routine, there is initially implemented S21 in which the target motor rotational angle è* determined in S5 is stored in a target-motor-rotational-angle storage portion which is a so-called first-in first-out memory. In the target-motor-rotational-angle storage portion, there is stored, in order, data of the target motor rotational angle è* obtained during a period from a previous time point which precedes a present time point by a predetermined time to the present time point. Next, S22 is implemented to obtain the actual motor rotational angle è based on a value detected by the motor-rotational-angle sensor 100. S22 is followed by S23 to obtain the motor-rotational-angle deviation Äè which is deviation of the actual motor rotational angle è with respect to the target motor rotational angle è*. Subsequently, S24 is implemented to judge whether an absolute value of the target motor rotational angle è* is smaller than a threshold è*ₒ and S25 is implemented to judge whether an absolute value of the actual motor rotational angle è is smaller than a threshold èₒ. Where the absolute value of the target motor rotational angle è* is smaller than the threshold èₒ and the absolute value of the actual motor rotational angle è is smaller than the threshold èₒ, the operation mode is determined to be the braking mode in S26, and the processing by the present sub routine is terminated.

Where either one of the target motor rotational angle è* and the actual motor rotational angle è are judged to be not smaller than the respective thresholds in S24 and S25, S27 is implemented to judge whether the absolute value of the target motor rotational angle è* is in process of decrease. In other words, it is judged in S27 whether the target motor rotational angle è* is approaching the neutral position 0, on the basis of the data stored in the target-motor-rotational-angle storage portion. Where the absolute value of the target motor rotational angle è* is judged to be in process of decrease, S28 is implemented to judge whether an absolute value of the motor-rotational-angle deviation Äè is larger than a threshold Äèₒ. Where the absolute value of the motor-rotational-angle deviation Äè is not larger than the threshold Äèₒ, the operation mode is determined to be the braking mode in S26. Where the absolute value of the motor-rotational-angle deviation Äè is larger than the threshold Äèₒ, the operation mode is determined to be the free mode in S29. Thus, the processing by the present sub routine is terminated. On the other hand, it is judged that in S27 that the target motor rotational angle è* is not in process of decrease, that is, where the target motor rotational angle è* is increasing or is maintained at a generally constant value except the neutral position, the operation mode is determined to be the control mode in S30, and the processing by the present sub routine is terminated.

After the processing by the above-described operation-mode determining sub routine in S7, the control flow goes to S8 to determine whether the operation mode is the free mode. Where the operation mode is not the free mode, S11 is implemented to output, to the inverter 104, a command for executing a control according to the operation mode determined in the operation-mode determining sub routine. The command is outputted to the inverter 104, together with a command value of the target supply current i*. On the other hand, where the operation mode is the free mode, S9 is implemented to judge whether a control according to the free mode is presently executed for the other stabilizer apparatus 14 which is not under current execution of a series of processing described above. Where the other stabilizer apparatus 14 is not under the control according to the free mode, S11 is implemented to output, to the inverter 104, a command for executing the control according to the free mode, and one execution of the present program is terminated. On the contrary, where it is judged that the above-indicated other stabilizer apparatus 14 is presently under the control according to the free mode, S10 is implemented to set the operational mode which had been determined to be the free mode in S8 into the braking mode. Subsequently, S11 is implemented to output, to the inverter 104, a command for executing a control according to the braking mode. Thus, one execution of the present program is terminated.

### 6. Functional Structure of Control Device

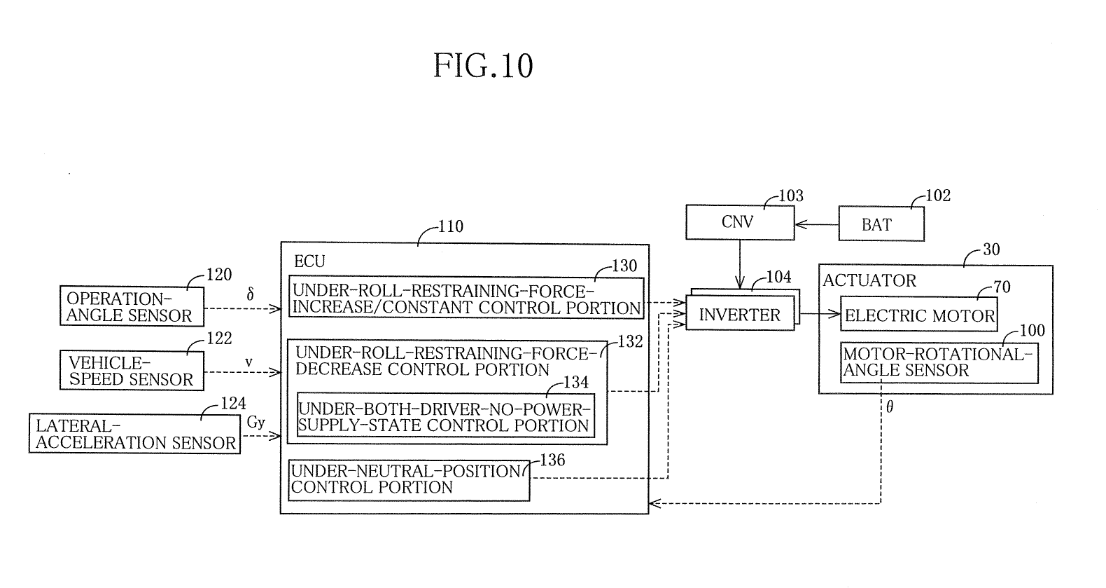

The ECU 110 as the control device for controlling the present stabilizer system 10 that functions by execution of the stabilizer control program explained above may be considered to have a functional structure shown in FIG. 10. According to the functional structure, the ECU 110 includes: an under-roll-restraining-force-increase/constant control portion 130 operable when the roll restraining force is in process of increase or when the roll restraining force is maintained at a constant value, as a functional portion which executes the processing in S1-S7, S11, S21-S25, S27, and S30; an under-roll-restraining-force-decrease control portion 132 operable when the roll restraining force is in process of decrease, as a functional portion which executes the processing in S1-S11 and S21-S29; an under-both-driver-no-power-supply-state control portion 134 as a functional portion which executes the processing in S8-S10, in particular, in the under-roll-restraining-force-decrease control portion 132; and an under-neutral-position control portion 136 as a functional portion which executes the processing in S1-S7, S11, and S21-S26.

What is claimed is:

1. A stabilizer system for a vehicle comprising:
a pair of stabilizer apparatus one of which is provided for a front-wheel side of the vehicle while the other of which is provided for a rear-wheel side of the vehicle and each of which includes: a stabilizer bar connected at opposite ends thereof to respective wheel holding members which respectively support left and right wheels of the vehicle; an actuator which includes an electric motor and which changes, by an operation of the electric motor, roll-restraining force to be exerted by the stabilizer bar; and a driver which is disposed between the electric motor and an electric power source for driving the electric motor; and
a control device which controls the electric motor of each of the pair of stabilizer apparatus via the corresponding driver and thereby controls an operation of the corresponding actuator,
wherein the control device includes an under-both-driver-no-power-supply-state control portion which controls at least one of the drivers of the pair of stabilizer apparatus to be placed into a phase-interconnection operation state in which terminals of respective phases of the corresponding electric motor are electrically connected to each other, when both of the drivers of the pair of stabilizer apparatus are in a no-power-supply operation state in which no power is supplied from the power source to the electric motor.

2. The stabilizer system according to claim 1, wherein the driver of each of the pair of stabilizer apparatus includes: (A) a plurality of pairs of switching elements, each pair being provided for the terminal of each phase of the corresponding electric motor and including (a-1) a positive-side switching element which is operable to electrically connect the corresponding terminal and a positive-side terminal of the electric power source to each other when the positive-side switching element is placed in an ON state and to disconnect the corresponding terminal and the positive-side terminal of the electric power source from each other when the positive-side switching element is placed in an OFF state and (a-2) a negative-side switching element which is operable to connect the corresponding terminal and a negative-side terminal of the electric power source to each other when the negative-side switching element is placed in an ON state and to disconnect the corresponding terminal and the negative-side terminal of the electric power source from each other when the negative-side switching element is placed in an OFF state; and (B) a switching-element controller which selectively places each of the switching elements between the ON state and the OFF state.

3. The stabilizer system according to claim 2, wherein the under-both-driver-no-power-supply-state control portion controls at least one of the drivers of the pair of stabilizer apparatus to be placed in an operation state in which only the positive-side switching elements or only the negative-side switching elements are all placed in the ON state, when both of the drivers of the pair of stabilizer apparatus are in the no-power-supply operation state.

4. The stabilizer system according to claim 1, wherein the control device controls the operation of the actuator of each of the pair of stabilizer apparatus based on a turning condition of the vehicle and thereby executes a control which permits the corresponding stabilizer bar to exert the roll-restraining force in accordance with the turning condition of the vehicle.

5. The stabilizer system according to claim 1, wherein the control device executes a control which permits the driver of each of the pair of stabilizer apparatus to be placed in the no-power-supply operation state, when the roll-restraining force exerted by the corresponding stabilizer bar is in process of decrease.

6. The stabilizer system according to claim 1,
wherein the stabilizer bar of each of the pair of stabilizer apparatus is constituted by including a pair of stabilizer bar members each of which includes a torsion bar portion disposed coaxially along an axis extending in a width direction of the vehicle and an arm portion which extends continuously from the torsion bar portion so as to intersect the torsion bar portion and which is connected at a leading end thereof to the corresponding wheel holding member, and
wherein the actuator of each of the pair of stabilizer apparatus is operable to rotate the torsion bar portions of the pair of stabilizer bar members relative to each other.

7. The stabilizer system according to claim 6,
wherein the actuator of each of the pair of stabilizer apparatus further includes a decelerator for decelerating rotation of the corresponding electric motor and a housing which holds the decelerator and the electric motor, and
wherein the torsion bar portion of one of the pair of stabilizer bar members is connected to the housing so as to be unrotatable relative to the housing while the torsion bar portion of the other of the pair of stabilizer bar members is connected to an output portion of the decelerator so as to be unrotatable to the output portion.
